(19) United States
(12) Patent Application Publication
(10) Pub. No.: US 2008/0229424 A1
(43) Pub. Date: Sep. 18, 2008

(54) Dispute resolution in a geo-spatial environment

(75) Inventors: William H. Harris, Woodside, CA (US); Chandrasekhar Thota, Palo Alto, CA (US); Raj Vasant Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/717,807

(22) Filed: Mar. 13, 2007

(51) Int. Cl. G06F 17/30

(52) U.S. Cl. 726/26

(57) ABSTRACT

A method, apparatus and system of dispute resolution in a geo-spatial environment are disclosed. In one embodiment, a method includes providing a wiki interface such that users modify and add profiles of others prior to the profiles being claimed, permitting an initial claimant to control editability of a wiki portion of a selected profile when the initial claimant claims the selected profile, capturing what personally identifiable information the initial claimant is willing to submit if the selected profile is disputed, placing the selected profile in dispute when a disputing claimant challenges an ownership of the selected profile by the initial claimant, electing a dispute resolution process that communication a code through a direct mail mechanism to a physical address associated with the selected profile, and allocating the selected profile to one of the initial claimant and the disputing claimant based on entry of the code in the selected profile.

### FIELD OF TECHNOLOGY

This disclosure relates generally to the technical fields of communications and, in one example embodiment, to a method, apparatus, and system of dispute resolution in a geo-spatial environment.

### BACKGROUND

Identity management may include a process of ensuring that a person controlling content of an online profile (e.g., an Internet profile) is actually the person represented in the online profile. For example, Jane Roberts of Marshall, Tex. may want to ensure that her online profile (e.g., identity) is protected against another user of a website (e.g., eBay, Amazon®, Paypal®, Facebook®, MySpace®, LinkedIN®, etc.) falsely claiming to be her.

The website may require email verification prior to allowing a user to access the online profile for the first time. However, a fraudulent user may create a temporary email address for the purpose of falsely claiming (e.g., hijacking) the online profile. For example, Candice, an impostor of Jane, may create a temporary account on an email system (e.g., Hotmail®, Gmail®, etc.) and use the temporary account to submit fraudulent verification of the online profile of Jane.

When the website is a geo-spatial website (e.g., Fatdoor®, Platial®, Zillow.com®, Movoto.com®, etc.), properly managing identity of users can be even more important because location information can transcend more easily into real life, as people's physical locations may be visible and represented.

### SUMMARY

A method, apparatus and system of dispute resolution in a geo-spatial environment are disclosed. In one aspect, a method includes providing a wiki interface such that users modify and/or add profiles of others prior to the profiles being claimed, permitting an initial claimant to control editability of a wiki portion of a selected profile when the initial claimant claims the selected profile, capturing what personally identifiable information the initial claimant is willing to submit if the selected profile is disputed, placing the selected profile in dispute when a disputing claimant challenges an ownership of the selected profile by the initial claimant, electing a dispute resolution process that communicates a code through a direct mail mechanism to a physical address associated with the selected profile and allocating the selected profile to one of the initial claimant and the disputing claimant based on entry of the code in the selected profile.

The method may further include temporarily disabling access to the selected profile a threshold window of time when the selected profile is placed in dispute. The method may also include capturing what personally identifiable information (e.g., a utility bill, a bank account routing information, a social security number, a driver's license, a passport and/or a birth certificate, etc.) the disputing claimant is willing to submit when disputing the selected profile, requesting the personally identifiable information from the initial claimant and the disputed claimant, and/or automatically disabling one of the initial claimant and the disputing claimant from a geo-spatial social network based on an analysis of the submitted personally identifiable information.

In addition, the method may include providing an interface to allow the initial claimant to swear that a persona identified in the selected profile is owned by the initial claimant when allocating permission of controlling editability of the wiki portion of the selected profile. Furthermore, the method may include automatically removing defamatory wiki edits by periodically comparing profiles against an unauthorized content meta-data stored in a database and flagging those profiles having content which match the unauthorized content meta-data as candidates of removal. The method may also include electing neighborhood moderators to serve as arbitrators of the dispute resolution process based on a geo-fenced election between users of the geo-spatial social network embodying an environment where wiki portions may be modifiable until they are claimed. Moreover, the method may include enabling the wiki portion of the selected profile when an email confirmation bounces back from one of the initial claimant and the disputing claimant owning permission rights to the selected profile. Additionally, the email confirmation may be requested every six months.

In another aspect, a system includes a profile module to include a number of wiki profiles (e.g., the wiki profiles may be convertible to claimed profiles when users claim the wiki profiles) and a number of claimed profiles, a process module to enable the users to claim the wiki profiles, one per each email address, so that the wiki profiles convert to claimed profiles upon an oath, declaration, and/or supplemental identification pledge of a claimant and a resolve module to arbitrate disputes between the claimant and at least one disputing claimant through an electronic key verification technique. In addition, the electronic key may be included in a mailer sent to an address location (e.g., tagged to each claimed wiki profile in the system) associated with a claimed wiki profile.

The system may further include a blocking module to temporarily disable access to disputed profiles in the system. Also, the wiki profiles may be modifiable by any user in the system and modifiable by the others only at the discretion of the claimant when claimed. In addition, the system may include a notification module to alert neighbors (e.g., the neighbors may be users having an address data a threshold distance away from the disputed profile) of a disputed profile and/or to provide an interface to neighbors to help clarify ownership between disputing claimants through a voting mechanism between neighbors. Moreover, the system may further include a verification module to confirm that information posted to any wiki profile and to any claimed profile does not violate a privacy policy in which defamatory content is prohibited and providing, in the interface to neighbors, a reporting mechanism such that neighbors submit violations of the privacy policy to an administrator of the system.

In yet another aspect, a method includes associating address information with profiles of a geo-spatial social network, enabling users a geo-fenced distance away from a particular profile to add content to the particular profile, converting the particular profile to proprietary profile that only is editable by a claimant when the claimant submits a claiming request of the profile, temporarily blocking the proprietary profile when a disputing party challenges the claimant's dominion over the proprietary profile, and releasing the proprietary profile to one of the claimant and the disputing party based on results of an electronic dispute resolution process in which a personally identifiable data is requested within a threshold window of time. The personally identifiable data may have been pre-committed by the claimant and may be requested of both the claimant and the disputing party at a time of dispute so as to provide forty-eight hours to upload the personally identifiable data to the geo-spatial social network.

The method may also include performing an optical character and graphical representation analysis on the personally identifiable data so as to verify authenticity of the personally identifiable data against a third party identity verification database. The method may further include mailing a double-postcard (e.g., the double-postcard may qualify as a first-class mail postcard having an embedded reply information in the double-postcard) that may be folded and sealed to an address associated with the proprietary profile which assigns an ownership of the proprietary profile to a user who applies a code provided in the double-postcard to the proprietary profile.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is an exemplary flow of a dispute resolution process in a geo-spatial environment, according to one embodiment.

FIG. 2 is a system view of a dispute module communicating with a neighborhood through a network, according to one embodiment.

FIG. 3 is an exploded view of the process module of FIG. 2, according to one embodiment.

FIG. 4 is an exploded view of the profile module of FIG. 2, according to one embodiment.

FIG. 5 is a user interface view of a map showing a location of a temporarily blocked disputed profile in a neighborhood, according to one embodiment.

FIG. 6 is a table view showing details of a dispute resolution process, according to one embodiment.

FIG. 7 is a diagrammatic system view of a data processing system in which any of the embodiments disclosed herein may be performed, according to one embodiment.

FIG. 8 is a front view of a double postcard, according to one embodiment.

FIG. 9 is a back view of the double postcard, according to one embodiment.

FIG. 10A is a process flow of the dispute module of FIG. 2, according to one embodiment

FIG. 10B is a continuation of the process flow of FIG. 10A showing additional processes, according to one embodiment

FIG. 10C is a continuation of the process flow of FIG. 10B showing additional processes, according to one embodiment.

FIG. 11 is a process flow of assigning an ownership of a disputed proprietary profile, according to one embodiment.

Other features of the present embodiments will be apparent from the accompanying drawings and from the detailed description that follows.

### DETAILED DESCRIPTION

A method, apparatus and system of dispute resolution in a geo-spatial environment are disclosed. In the following description, for the purposes of explanation, numerous specific details are set forth in order to provide a thorough understanding of the various embodiments. It will be evident, however to one skilled in the art that the various embodiments may be practiced without these specific details.

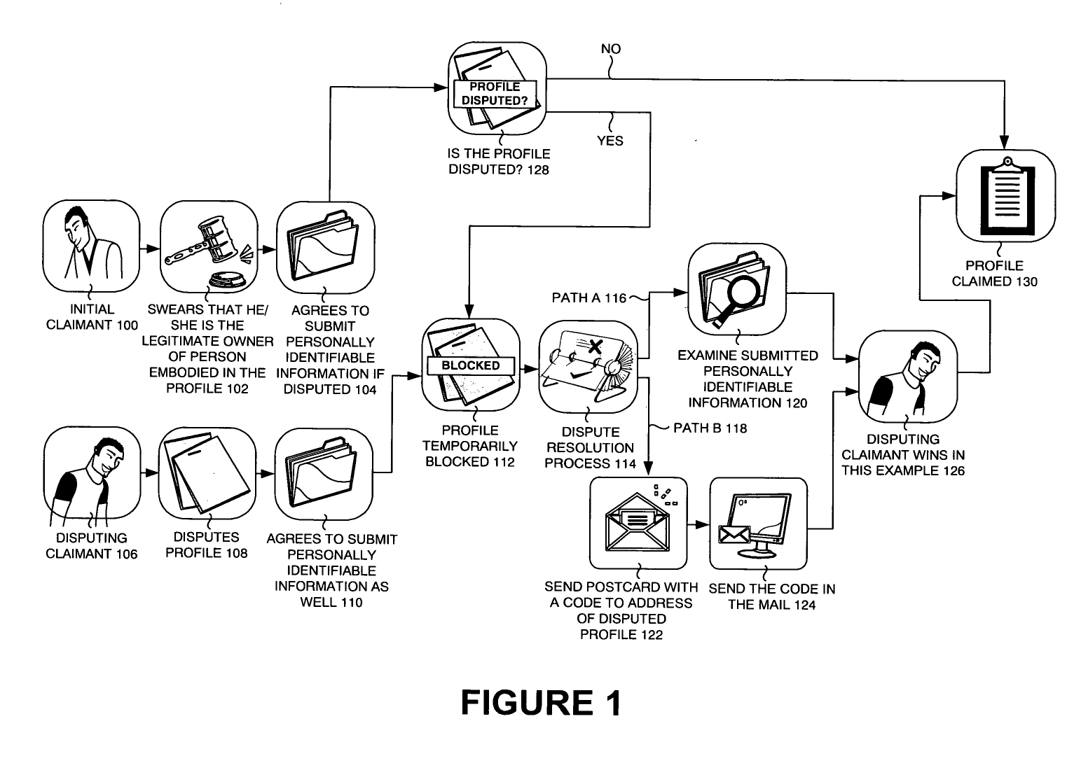

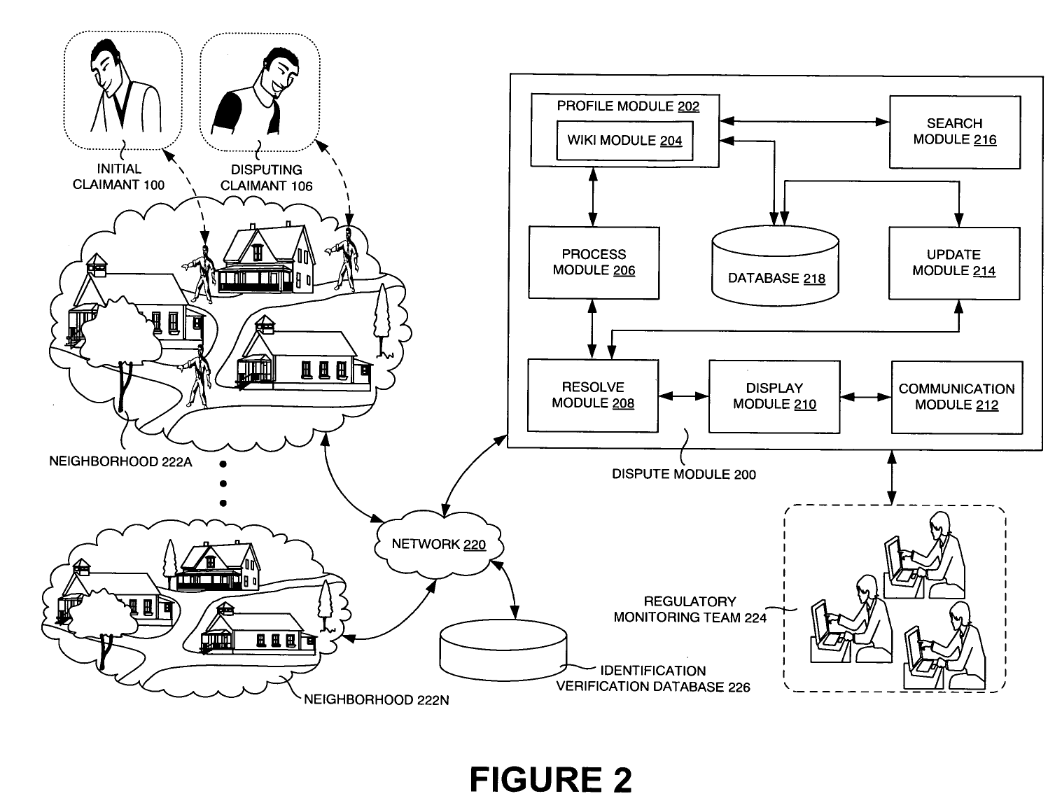

In one embodiment, a method includes providing a wiki interface such that users modify and add profiles of others prior to the profiles being claimed, permitting an initial claimant (e.g., the initial claimant 100 of FIG. 1-2) to control editability of a wiki portion of a selected profile when the initial claimant claims the selected profile, capturing what personally identifiable information the initial claimant is willing to submit if the selected profile is disputed, placing the selected profile in dispute when a disputing claimant (e.g., the disputing claimant 106 of FIG. 1-2) challenges an ownership of the selected profile by the initial claimant, electing a dispute resolution process (e.g., the dispute resolution process 114 of FIG. 1) that communicates a code through a direct mail mechanism to a physical address associated with the selected profile, and allocating the selected profile to one of the initial claimant and the disputing claimant based on entry of the code in the selected profile.

In another embodiment, a system includes a profile module (e.g., the profile module 202 illustrated in FIG. 2) to include a number of wiki profiles (e.g., the wiki profiles may be convertible to claimed profiles when users claim the wiki profiles) and a number of claimed profiles, a process module (e.g., the process module 206 of FIG. 2) to enable the users to claim the wiki profiles, one per each email address, so that the wiki profiles convert to claimed profiles upon an oath, declaration, and/or supplemental identification pledge of a claimant, and a resolve module (e.g., the resolve module 208 of FIG. 2) to arbitrate disputes between the claimant and at least one disputing claimant through an electronic key verification technique.

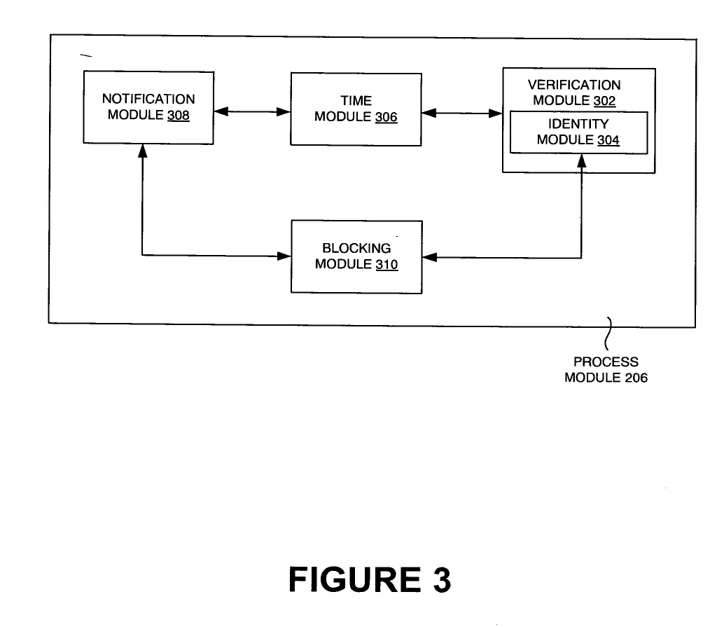

In yet another embodiment, a method includes associating address information with profiles of a geo-spatial social network (e.g., using the profile module 202 of FIG. 2), enabling users a geo-fenced distance away from a particular profile to add content to the particular profile, converting the particular profile to a proprietary profile that only is editable by a claimant when the claimant submits a claiming request of the profile, temporarily blocking (e.g., using the blocking module 310 of FIG. 3) the proprietary profile when a disputing party challenges the claimant's dominion over the proprietary profile, and releasing the proprietary profile to one of the claimant and the disputing party based on results of an electronic dispute resolution process in which a personally identifiable data is requested within a threshold window of time.

FIG. 1 is an exemplary flow of a dispute resolution process in a geo-spatial environment, according to one embodiment. In one example embodiment, illustrated in FIG. 1, an initial claimant 100 may be a first person to claim a wiki profile associated with an address data in a geo-spatial social network. In operation 102, the initial claimant 100 swears that he/she is a legitimate owner of person embodied in the wiki profile. In operation 104, the initial claimant 100 agrees to submit personally identifiable information (e.g., a utility bill number, a driver's license number, a social security number etc.), if the claimed profile is placed in dispute. In operation 128, it is determined whether the profile is disputed or not. If it is determined that profile is not placed in dispute, the ownership of the wiki profile is assigned to the initial claimant.

In another example embodiment illustrated in FIG. 1, a disputing claimant 106 may be one who challenges an ownership of the claimed profile by the initial claimant 100. In state 108, the disputing claimant 106 has a dispute with the initial claimant 100, so that the selected profile may be placed in dispute. In operation 110, the disputing claimant 106 also agrees to submit personally identifiable information. In operation 112, access to the selected profile may be temporarily blocked (e.g., the profile may be blocked from viewing, searches etc.) when the selected profile is in dispute. Also, the neighbors within a threshold region of the disputed profile may be alerted of the disputed profile and prompted to clarify the authenticity of the claimants. The dispute resolution process 114 leads to a path A 116 and/or a path B 118 as illustrated in example embodiment of FIG. 1. The path A 116 involves operation 120. The path B 118 involves operation 122.

In path A 116, a request is sent to the claimants to submit their personally identifiable information (e.g., as they agreed to). In operation 120, an examination of the personally identifiable information submitted by the initial claimant 100 and the disputing claimant 106 is carried out by arbitrators of the dispute resolution process (e.g., through the regulatory monitoring team 224 illustrated in FIG. 2). The examination may include performing an optical character and graphical representation analysis on the personally identifiable data so as to verify its authenticity against a third party identity verification database. If any one of the claimants does not submit the personally identifiable information within a threshold amount of time (e.g., 48 hours), then he/she is denied ownership of the disputed profile.

In operation 122, a postcard (e.g., a double postcard) containing a pass code is sent to a physical address of the disputed profile to assign the ownership of the disputed profile to one of the claimants. In operation 124, a real occupant (disputing claimant 106 in this case) applies the pass code online to claim the disputed profile. In state 126, the disputing claimant 106 wins in the dispute and gets a right to ownership of the profile as illustrated in the example embodiment of FIG. 1. In operation 130, the profile is claimed by the real occupant (disputing claimant 106 in this example) based on the path A and/or or path B (e.g., as illustrated).

FIG. 2 is a system view of a dispute module 200 communicating with a neighborhood 222A-N through a network 220. Particularly, FIG. 2 illustrates the initial claimant 100, the disputing claimant 106, the dispute module 200, a profile module 202, a wiki module 204, a process module 206, a resolve module 208, a display module 210, a communication module 212, an update module 214, a search module 216, a database 218, the network 220, the neighborhood 222A-N, a regulatory monitoring team 224 and an identification verification database 226, according to one embodiment.

The initial claimant 100 may be the claimant who initially claims the wiki profile associated with the address data. The disputing claimant 106 may be the claimant who challenges the ownership of the profile claimed by the initial claimant. The dispute module 200 may assign the disputed profile to one of the initial claimant and the disputing party based on the results of the dispute resolution process. The profile module 202 may include any number of wiki profiles (e.g., profiles that may be editable by any user) and/or claimed profiles having the address data associated with a physical location in the neighborhood 222A-N of the geo-spatial social network. The wiki module 204 may enable creation and/or updates of the wiki profiles associated with users in the neighborhood 222A-N (e.g., which are not yet claimed).

The process module 206 may transform the wiki profile into the claimed profile when the user claims the wiki profile (e.g., based on an oath, declaration and/or supplemental identification pledge made by the user as a claimant). The resolve module 208 may arbitrate disputes between the initial claimant and disputing claimants in the neighborhood 222A-N through an electronic key verification technique.

The display module 210 may prompt the query to the claimants of the disputed profile to determine what personally identifiable information (e.g., the utility bill, the social security number, the driving license, the security password received at home address, etc.) the initial claimant and the disputing claimant are willing to submit. The communication module 212 may communicate the code to the physical address associated with the selected profile through a direct mail mechanism (e.g., the double-post card) when the selected profile is in dispute.

The update module 214 may provide a wiki interface that enables users to modify and/or add profiles of others prior to the profile being claimed. The search module 216 may control and/or enable searching of the profiles (e.g., both wiki and claimed profiles) of the other users until the profile is placed in dispute. The database 218 may contain the address data associated with the profiles (e.g., the wiki profiles and/or the claimed profiles) of the user in the neighborhood 222A-N.

The network 220 may enable communication between the dispute module 200, the users in the neighborhood 222A-N and/or the identification verification database 226. The neighborhood 222A-N may be a geographically localized community located within a territory, city, town and/or suburb associated with the geo-spatial environment.

The regulatory/monitoring team 224 may be moderators elected to serve as arbitrators of the dispute resolution process (e.g., the dispute resolution process 114 of FIG. 1) based on a geo-fenced election between the users in the neighborhood 222A-N. The identification verification database 226 may be the third party database containing the verification data used to verify authenticity of the personally identifiable data (e.g., the utility bill, the driver's license, social security number, etc.) submitted by the initial claimant and the disputing claimant when the claimed profile is in dispute.

In the example embodiment illustrated in FIG. 2, the display module 200 communicates with the neighborhood 222A-N and the identification verification database 226 through the network 220. In addition, the dispute module 200 interacts with the regulatory monitoring team 224. The dispute module 200 includes the profile module 202, the process module 206, the resolve module 208, the display module 210, the communication module 212, the update module 214, the search module 216 and the database 218. The profile module 202 includes the wiki module 204 and communicates with the process module 206, the search module 216 and the database 218.

The resolve module 208 as illustrated in the example embodiment of FIG. 2 communicates with the process module 206, the display module 210 and the update module 214. The display module 210 communicates with the communication module 212. The update module 214 interacts with the database 218 as illustrated in the example embodiment shown in FIG. 2.

The wiki interface may be provided such that users modify and/or add profiles of others (e.g., using the update module 214 of FIG. 2), prior to the profiles being claimed. Personally identifiable information that the initial claimant 100 is willing to submit if the selected profile is disputed may be captured. The selected profile may be placed in dispute when the disputing claimant 106 challenges the ownership of the selected profile by the initial claimant 100.

Access to the selected profile may be disabled temporarily (e.g., using the blocking module 310 of FIG. 3) for a threshold window of time when the selected profile is placed in dispute. The personally identifiable information may also be requested from the initial disputed claimant 106. The dispute resolution process (e.g., the dispute resolution process 114 of FIG. 1) may be elected (e.g., the process whereby the code may be communicated through the direct mail mechanism to the physical address associated with the selected profile). The wiki portion of the selected profile may be enabled when an email confirmation bounces back from one of the initial claimant 100 and the disputing claimant 106 owning permission rights to the selected profile.

The profile module 202 may process a number of wiki profiles that are convertible to claimed profiles (when users claim the wiki profiles), and/or a number of claimed profiles. The process module 206 may enable the users to claim the wiki profiles (e.g., one per each email address), so that the wiki profiles convert to claimed profiles upon the oath, the declaration, and/or the supplemental identification pledge of the claimant (e.g., the initial claimant 100 of FIG. 1).

The resolve module 208 may arbitrate disputes (e.g., the disputes may also be arbitrated by the moderators of the neighborhood) between the claimant and at least one disputing claimant through the electronic key verification technique. The proprietary profile may be released to one of the initial claimant and the disputing party based on results of an electronic dispute resolution process in which the personally identifiable data is requested within a threshold window of time.

Optical character and graphical representation analysis may be performed on the personally identifiable data so as to verify (e.g., using the verification module 302 of FIG. 3) authenticity of the personally identifiable data against the third party identity verification database. A double-postcard that is folded and sealed may be mailed to the address (e.g., the address associated with the proprietary profile) which assigns the ownership of the proprietary profile to a user who applies the code provided in the double-postcard to the proprietary profile.

FIG. 3 is an exploded view of the process module 206 of FIG. 2, according to one embodiment. Particularly, FIG. 3 illustrates a verification module 302, an identity module 304, a time module 306, a notification module 308 and a blocking module 310, according to one embodiment.

The verification module 302 may confirm the information posted to the wiki profile and/or the claimed profile. The identity module 304 may request the personally identifiable information (e.g., the utility bill, the social security number, the driver's license, etc.) from both the initial claimant and the disputed claimant if the selected profile is disputed. The time module 306 may provide a threshold window of time (e.g., 48 hours) to upload the personally identifiable information to the geo-spatial network from both the initial claimant and the disputed claimant. The notification module 308 may alert the neighbors (e.g., located a threshold distance away from the disputed profile) of the dispute (e.g., and/or request the neighbors to participate in verifying the authenticity of claims to ownership of the profile). The blocking module 310 may temporarily block access to a selected profile when the selected profile is placed in dispute.

In one example embodiment illustrated in FIG. 3, the verification module 302 includes the identity module 304 and communicates with the time module 306 and the blocking module 310. The notification module 308 communicates with the time module 306 and the blocking module 310, according to the example embodiment of FIG. 3.

A selected profile may be allocated to one of an initial claimant (e.g., the initial claimant 100 of FIG. 1-2) and a disputing claimant (e.g., the disputing claimant 106 of FIG. 1-2) based on entry of a code in the selected profile. Moreover, one of the initial claimant and the disputing claimant may be disabled from the geo-spatial social network based on an analysis of a submitted (e.g., by the claimant) personally identifiable information.

The process module 206 may enable the users to claim the wiki profiles, one per each email address, so that the wiki profiles convert to claimed profiles upon the oath, the declaration, and/or the supplemental identification pledge of the claimant (e.g., the initial claimant 100 of FIG. 1). In addition, the blocking module 310 may temporarily disable the access to the disputed profiles in the system. Furthermore, the verification module 302 may confirm that information posted to any wiki profile and/or to any claimed profile does not violate a privacy policy in which defamatory content is prohibited, and may provide, in the interface to the neighbors, a reporting mechanism such that the neighbors submit violations of the privacy policy to an administrator of the system.

The notification module 308 may alert neighbors (e.g., in the geo-spatial social network) of the disputed profile, and/or may provide an interface to the neighbors (e.g., users having an address data a threshold distance away from the disputed profile) to help clarify ownership between disputing claimants through a voting mechanism between the neighbors. Also, the proprietary profile may be blocked temporarily (e.g., using the blocking module 310 of FIG. 3) when the disputing party challenges the claimant's dominion over the proprietary profile. Additionally, the proprietary profile may be released to one of the initial claimant and the disputing party based on results of the electronic dispute resolution process in which the personally identifiable data is requested within a threshold window of time (e.g., 48 hours).

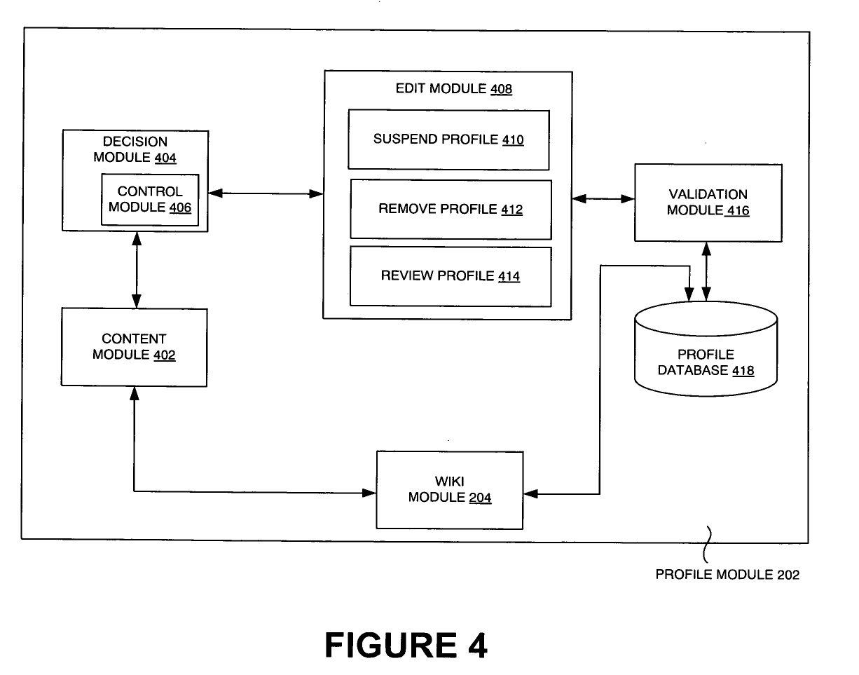

FIG. 4 is an exploded view of the profile module 202 of FIG. 2, according to one embodiment. Particularly, FIG. 4 illustrates the wiki module 204, a content module 402, a decision module 404, a control module 406, an edit module 408, a suspend profile 410, a remove profile 412, a review profile 414, a validation module 416 and a profile database 418.

The profile module 202 may generate a number of profiles (e.g., both wiki and claimed) created by the user(s) in the geo-spatial environment. The wiki module 204 may provide wiki profiles associated with the address data of the people in the geo-spatial network and/or may enable the users to edit the different wiki profiles prior to claiming the wiki profile. The content module 402 may generate content meta-data associated with profiles both wiki and claimed, stored in the profile database 418.

The decision module 404 may compare, periodically, the profiles against an unauthorized content meta-data stored in profile database and/or may flag the profiles having unauthorized content meta-data as candidates of removal. The control module 406 may control the addition of the unauthorized content meta-data into the wiki profiles in the geo-spatial social network.

The edit module 408 may suspend, remove, and/or review the profile and/or may enable the user to edit the wiki profiles in the geo-spatial social network. The suspend profile 410 may perform suspension of unauthorized content meta-data in the profile. The remove profile operation 412 may perform removal of the unauthorized content meta-data in the profiles. The review profile operation 414 may conduct the review of the unauthorized content meta-data in the profiles.

The validation module 416 may validate a complaint about defamation in a wiki profile reported by a user. The profile database 418 may contain the information associated with the profiles (e.g., both wiki and claimed) and/or may also track changes in the wiki profiles that are added in the geo-spatial social network.

In the example embodiment illustrated in FIG. 4, the wiki module 204 communicates with the decision module 404 through the content module 402. The wiki module 204 communicates with the profile database 418 and the content module 402. The decision module 404 contains the control module and communicates with the content module 402 and the edit module 408, according to the example embodiment illustrated in FIG. 4. In addition, the edit module 408 includes the suspend profile 410, the remove profile 412 and the review profile 414. The validation module 416 as illustrated in FIG. 4 interacts with the edit module 408 and the profile database 418.

Furthermore, the initial claimant (e.g., the initial claimant 100 of FIG. 1-2) may be permitted to control editability of the wiki portion of the selected profile when the initial claimant claims the selected profile. Moreover, the interface may be provided to allow the initial claimant to swear that a persona identified in the selected profile is owned by the initial claimant when allocating permission of controlling editability of the wiki portion of the selected profile.

Defamatory wiki edits may be automatically removed by periodically comparing profiles against the unauthorized content meta-data stored in the database (e.g., the profile database 418 of FIG. 4) and those profiles having content which matches the unauthorized content meta-data may be flagged as candidates of removal. Furthermore, the profile module may include wiki profiles (e.g., the wiki profiles are convertible to claimed profiles when users claim the wiki profiles) and/or claimed profiles.

Additionally, address information may be associated with profiles of the geo-spatial social network. Users that are geo-fenced distance away from the particular profile may be enabled to add content to the particular profile. Also, the particular profile may be converted to a proprietary profile that only is editable by the claimant when the claimant submits a claiming request of the profile.

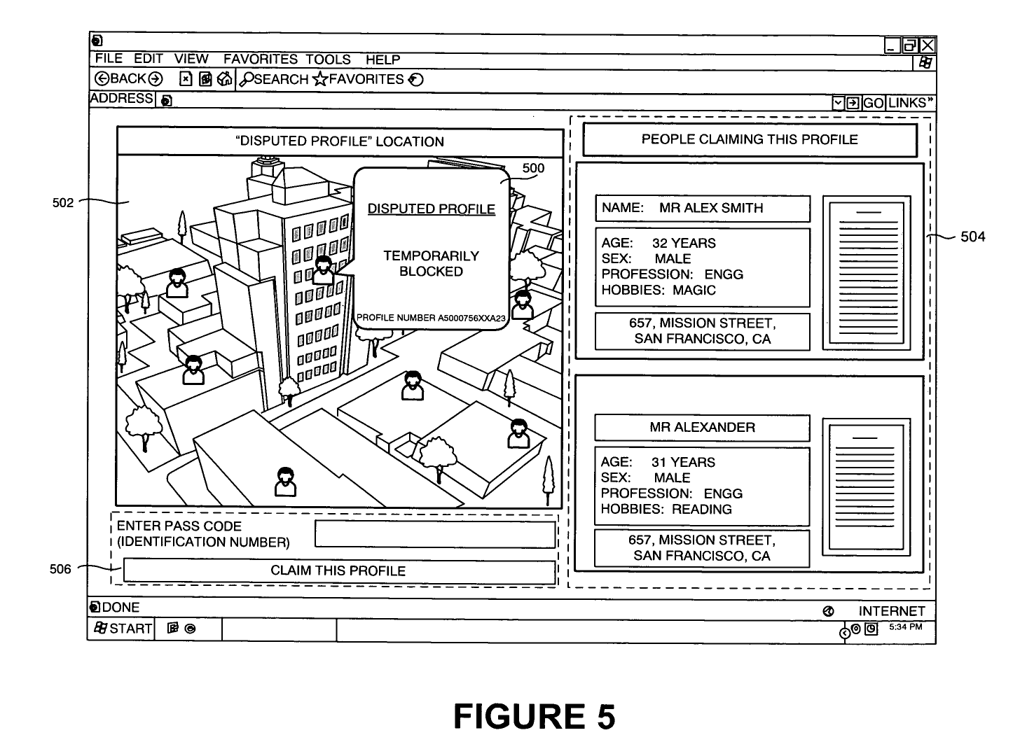

FIG. 5 is a user interface view of a map showing a location of the temporarily blocked disputed profile in a neighborhood 502, illustrating a pop-up 500, the neighborhood 502, a people claiming this profile block 504 and an enter pass code option 506, according to one embodiment.

The pop-up 500 may alert a user in the neighborhood that the profile is disputed when the user selects to view the disputed profile. The neighborhood 502 may graphically represent the location of the disputed profile along with the other profiles in the geo-spatial social network and may also indicate that access to the disputed profiles is temporarily disabled and/or blocked until the electronic dispute resolution process is completed. The people claiming this profile block 504 may simultaneously display the information associated with the initial claimant and/or the disputing claimants who challenge the ownership of the selected profile by the initial claimant. The enter pass code option 506 may enable one of the initial and disputed claimant to enter the code provided in the double-postcard (e.g., first-class mail postcard having an embedded reply information) that is mailed to the address associated with the proprietary profile when the dispute is resolved.

In the example embodiment illustrated in FIG. 5, the user interface view may graphically visualize, in the map, the wiki profiles, the claimed profiles and the disputed profiles having the address data associated with the particular physical location of the user in the neighborhood 502 of the geo-spatial social network. The user interface view may also enable the claimants (e.g., initial claimants, disputed claimants) to enter the code delivered (e.g., through physical mail) to the address associated with the any one of the claimant.

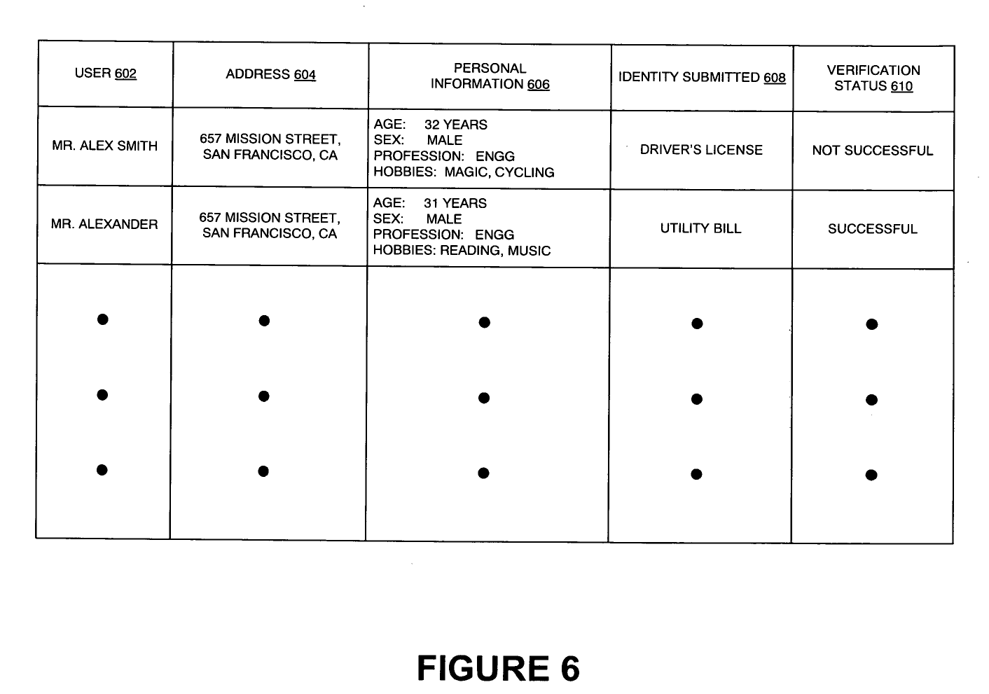

FIG. 6 is a table view showing details of a dispute resolution process, according to one embodiment. Particularly, FIG. 6 illustrates a user field 602, an address field 604, a personal information field 606, an identity submitted field 608, and a verification status field 610, according to one embodiment.

The user field 602 may display the names of the claimants (e.g., initial claimant and disputing claimants) who have claimed the particular wiki profile associated with the address data in the geo-spatial environment. The address field 604 may represent the location meta-data (e.g., area, city, country, zip code) associated with the disputed wiki profile in the geo-spatial environment. The personal information field 606 may show the personal information (e.g., age, sex, profession, hobbies, etc.) of the claimants who claimed the same wiki profile.

The identity submitted field 608 may be the personally identifiable information submitted by the initial claimant and/or the disputing claimant during the dispute resolution process. The verification status field 610 may indicate a status when the personally identifiable information submitted by both the initial claimant and the disputed claimant is examined.

In the example embodiment illustrated in FIG. 6, the user field 602 displays “Mr. Alex Smith” in the first row and “Mr. Alexander” in the second row of the user field column 602. The address field 604 displays “657 Mission Street, San Francisco, Calif.” in the first row and also in the second row of the address field column 604. The personal information field 606 displays “Age: 32 years, Sex: Male, Profession: Engg., Hobbies: Magic, Cycling” in the first row and “Age: 31 years, Sex: Male, Profession: Engg., Hobbies: Reading, Music” in the second row of the personal information field column 606. The identity submitted field 608 shows “Driver's License” in the first row and “Utility Bill” in the second row of the identity submitted field column 608. The verification status field 610 shows “Not successful” in the first row and “Successful” in the second row of the verification status field column 610.

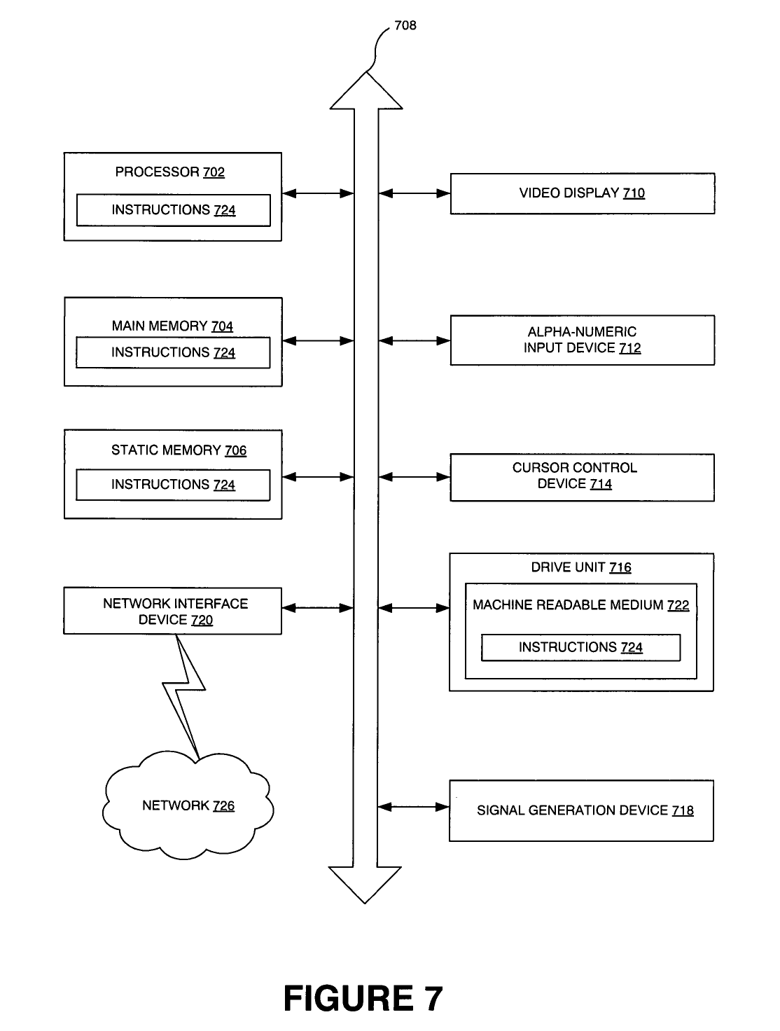

FIG. 7 is a diagrammatic system view 700 of a data processing system in which any of the embodiments disclosed herein may be performed, according to one embodiment. Particularly, the diagrammatic system view 700 of FIG. 7 illustrates a processor 702, a main memory 704, a static memory 706, a bus 708, a video display 710, an alpha-numeric input device 712, a cursor control device 714, a drive unit 716, a signal generation device 718, a network interface device 720, a machine readable medium 722, instructions 724, and a network 726, according to one embodiment.

The diagrammatic system view 700 may indicate a personal computer and/or a data processing system in which one or more operations disclosed herein are performed. The processor 702 may be a microprocessor, a state machine, an application specific integrated circuit, a field programmable gate array, etc. (e.g., Intel® Pentium® processor). The main memory 704 may be a dynamic random access memory and/or a primary memory of a computer system.

The static memory 706 may be a hard drive, a flash drive, and/or other memory information associated with the data processing system. The bus 708 may be an interconnection between various circuits and/or structures of the data processing system. The video display 710 may provide graphical representation of information on the data processing system. The alpha-numeric input device 712 may be a keypad, a keyboard and/or any other input device of text (e.g., a special device to aid the physically handicapped). The cursor control device 714 may be a pointing device such as a mouse.

The drive unit 716 may be a hard drive, a storage system, and/or other longer term storage subsystem. The signal generation device 718 may be a bios and/or a functional operating system of the data processing system. The network interface device 720 may be a device that may perform interface functions such as code conversion, protocol conversion and/or buffering required for communication to and from the network 726. The machine readable medium 722 may provide instructions on which any of the methods disclosed herein may be performed. The instructions 724 may provide source code and/or data code to the processor 702 to enable any one/or more operations disclosed herein.

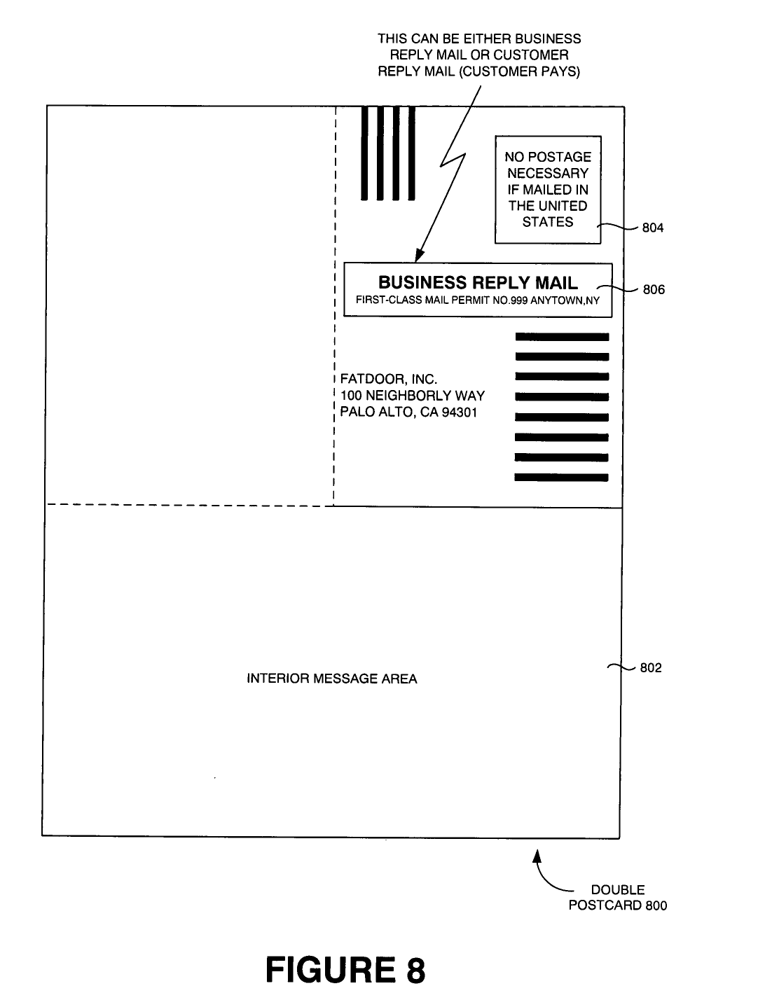

FIG. 8 is a front view of a double postcard 800, according to one embodiment. Particularly, FIG. 8 illustrates an interior message area 802, a block 804 and a business reply mail block 806, according to one embodiment. The double postcard 800 may contain a message (e.g., the code) mailed to the physical address associated with the real occupant of the disputed profile. The interior message area 802 may be the inside portion of the double postcard 800, and/or may contain the secret pass code allocated to the real occupant of the disputed profile to reclaim the selected profile which is in dispute. The block 804 may display the information ‘no postage necessary if mailed in the United States,’ indicating that postage would not be required for a claimant within the United States.

The business reply mail block 806 may represent a business reply mail or a customer reply mail provided by postal authorities, through which the real occupant of the disputed profile is communicated with. A mailer (e.g., the regulatory monitoring team 224 of FIG. 2 of the dispute resolution process) wishing to communicate mail by freepost may first have to obtain a business reply permit and design the envelopes, double postcards, and/or labels according to the standards specified by the United States Postal Service. The block 804 may be on the front face of the double postcard 800. Also, the front face of the double postcard 800 may contain the business reply mail block 806. In the example embodiment illustrated in FIG. 8, the business reply mail 806 displays the permit number ‘999, Anytown, N.Y.’. In addition the front face 800 of the double postcard contains an address of the sender (e.g., ‘Fatdoor, 100 Neighborly Way, Palo Alto, Calif. 94301’).

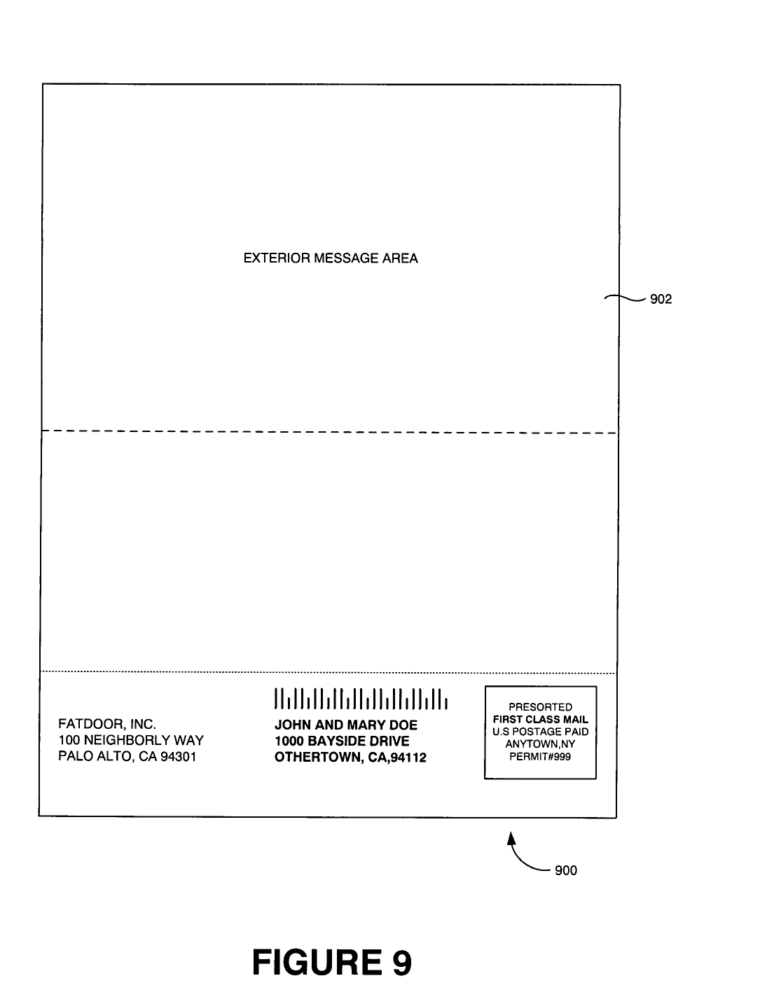

FIG. 9 is a back view of the double postcard 900, according to one embodiment. Particularly, FIG. 9 illustrates an exterior message area 902, according to one embodiment. The exterior message area 902 may contain the content meta-data used to communicate with the real occupant of the disputed profile. In the example embodiment illustrated in FIG. 9, the back view of the post card shows an address associated with the address of the real occupant. In addition, the double post card used for communicating with the real occupant of the disputed profile also displays the address of the sender who is trying to resolve the dispute.

In the example embodiment illustrated in FIG. 9, the back side view 900 of the double postcard may include an exterior message area 902, an address of the recipient (e.g., ‘John and Mary Doe, 1000 Bayside Drive, Other town, Calif., 94112’), an address of the sender (e.g., ‘Fatdoor Inc., 100 Neighborly way, Palo Alto, Calif. 94301’) and a block to show, for example, that the double postcard is a presorted First Class Mail with U.S. Postage PAID Anytown, N.Y., Permit #999.

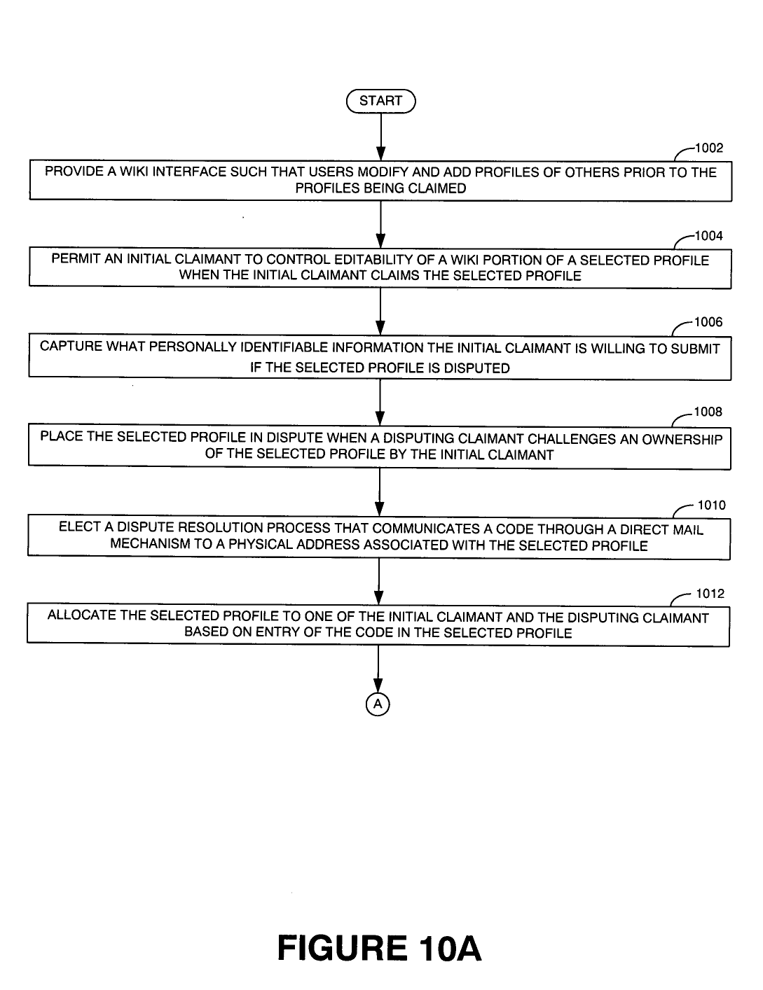

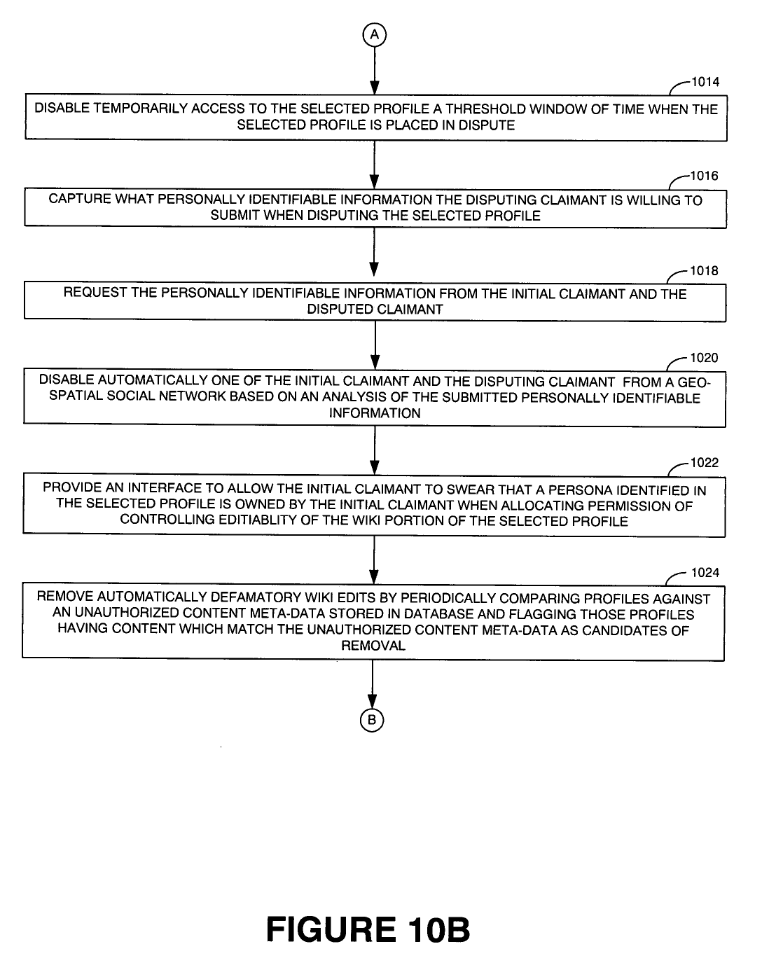

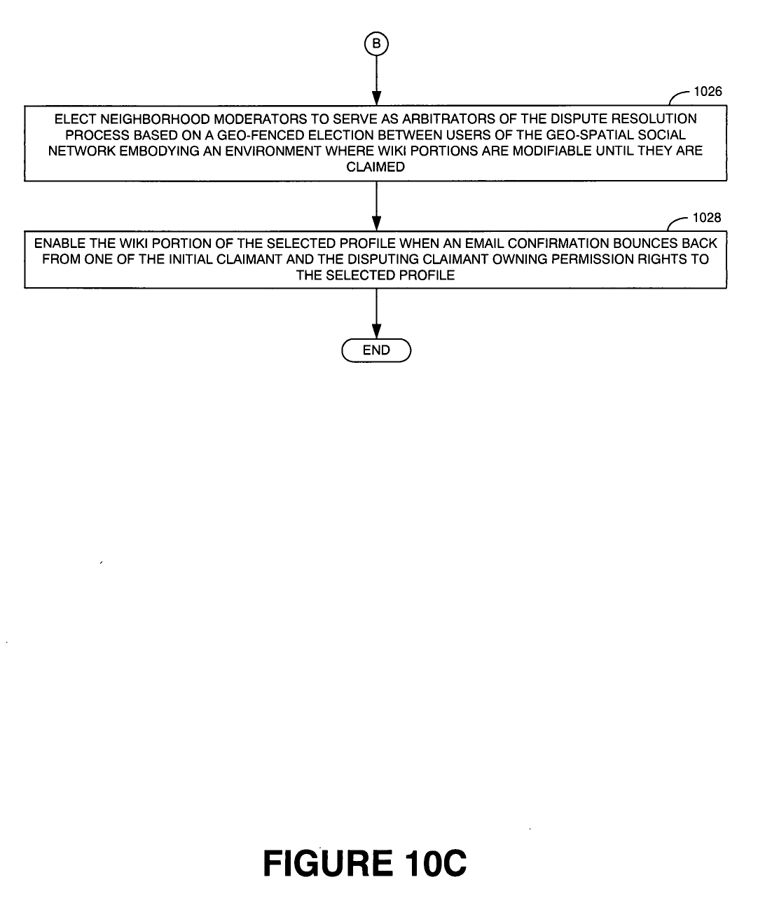

FIG. 10A is a process flow of the dispute module 200 of FIG. 2, according to one embodiment. In operation 1002, a wiki interface may be provided such that users modify and/or add profiles of others prior to the profiles being claimed. In operation 1004, an initial claimant may be permitted to control editability of a wiki portion of a selected profile when the initial claimant claims the selected profile. In operation 1006, personally identifiable information the initial claimant is willing to submit if the selected profile is disputed may be captured.

In operation 1008, the selected profile may be placed in dispute when a disputing claimant challenges an ownership of the selected profile by the initial claimant. In operation 1010, a dispute resolution process may be elected that communicates a code through a direct mail mechanism to a physical address associated with the selected profile. In operation 1012, the selected profile may be allocated to one of the initial claimant and the disputing claimant based on entry of the code in the selected profile.

FIG. 10B is a continuation of the process flow of FIG. 10A showing additional processes, according to one embodiment. In operation 1014, access to the selected profile may be disabled temporarily for a threshold window of time when the selected profile is placed in dispute. In operation 1016, personally identifiable information the disputing claimant is willing to submit when disputing the selected profile may be captured. In operation 1018, the personally identifiable information may be requested from the initial claimant and the disputed claimant. In operation 1020, one of the initial claimant and the disputing claimant may be disabled automatically from a geo-spatial social network based on an analysis of the submitted personally identifiable information.

In operation 1022, an interface may be provided to allow the initial claimant to swear that a persona identified in the selected profile is owned by the initial claimant when allocating permission of controlling editability of the wiki portion of the selected profile. In operation 1024, defamatory wiki edits may be removed automatically by periodically comparing profiles against an unauthorized content meta-data stored in database and those profiles having content which matches the unauthorized content meta-data may be flagged as candidates of removal.

FIG. 10C is a continuation of the process flow of FIG. 10B showing additional processes, according to one embodiment. In operation 1026, neighborhood moderators may be elected to serve as arbitrators of the dispute resolution process based on a geo-fenced election between users of the geo-spatial social network embodying an environment where wiki portions are modifiable until they are claimed. In operation 1028, the wiki portion of the selected profile may be enabled when an email confirmation bounces back from one of the initial claimant and the disputing claimant owning permission rights to the selected profile.

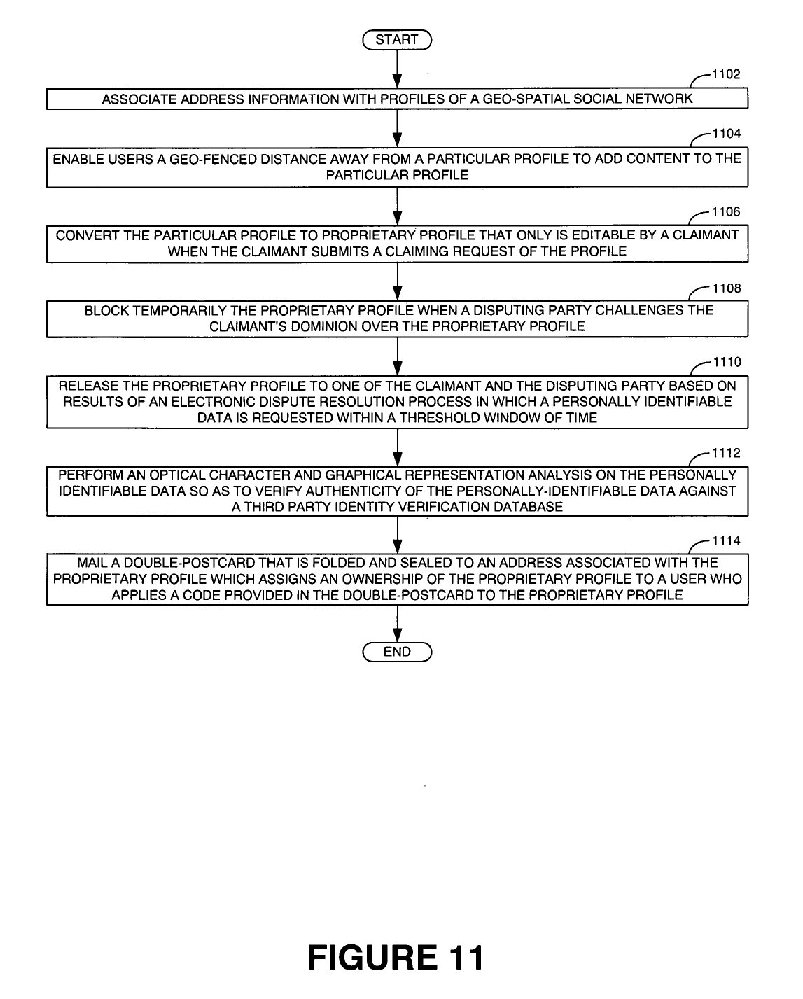

FIG. 11 is a process flow of assigning an ownership of a disputed proprietary profile, according to one embodiment. In operation 1102, address information may be associated with profiles of a geo-spatial social network. In operation 1104, users a geo-fenced distance away from a particular profile may be enabled to add content to the particular profile. In operation 1106, the particular profile may be converted to a proprietary profile that only is editable by a claimant when the claimant submits a claiming request of the profile. In operation 1108, the proprietary profile may be blocked temporarily when a disputing party challenges the claimant's dominion over the proprietary profile.

In operation 1110, the proprietary profile may be released to one of the claimant and the disputing party based on results of an electronic dispute resolution process in which a personally identifiable data is requested within a threshold window of time. In operation 1112, an optical character and graphical representation analysis may be performed on the personally identifiable data so as to verify authenticity of the personally identifiable data against a third party identity verification database. In operation 1114, a double-postcard that is folded and sealed may be mailed to an address associated with the proprietary profile which assigns an ownership of the proprietary profile to a user who applies a code provided in the double-postcard to the proprietary profile.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated ASIC circuitry and/or in Digital Signal, Processor DSP circuitry).

For example, the dispute module 200, the profile module 202, the wiki module 204, the process module 206, the resolve module 208, the display module 210, the communication module 212, the update module 214, the search module 216, the verification module 302, the identity module 304, the time module 306, the notification module 308, the blocking module 310, the content module 402, the decision module 404, the control module 406, the edit module 408, the validation module 416 and other modules of FIGS. 1-11 may be embodied through a dispute circuit, a profile circuit, a wiki circuit, a process circuit, a resolve circuit, a display circuit, a communication circuit, an update circuit, a search circuit, a verification circuit, an identity circuit, a time circuit, a notification circuit, a blocking circuit, a content circuit, a decision circuit, a control circuit, an edit circuit, a validation circuit and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method comprising:
providing a wiki interface such that users modify and add profiles of others prior to the profiles being claimed;
permitting an initial claimant to control editability of a wiki portion of a selected profile when the initial claimant claims the selected profile;
capturing what personally identifiable information the initial claimant is willing to submit if the selected profile is disputed;
placing the selected profile in dispute when a disputing claimant challenges an ownership of the selected profile by the initial claimant;
electing a dispute resolution process that communicates a code through a direct mail mechanism to a physical address associated with the selected profile; and
allocating the selected profile to one of the initial claimant and the disputing claimant based on entry of the code in the selected profile.

2. The method of claim 1 further comprising temporarily disabling access to the selected profile a threshold window of time when the selected profile is placed in dispute.

3. The method of claim 2 further comprising:
capturing what personally identifiable information the disputing claimant is willing to submit when disputing the selected profile;
requesting the personally identifiable information from the initial claimant and the disputed claimant; and
automatically disabling one of the initial claimant and the disputing claimant from a geo-spatial social network based on an analysis of the submitted personally identifiable information.

4. The method of claim 3 wherein the personally identifiable information is at least one of a utility bill, a bank account routing information, a social security number, a driver's license, a passport, and a birth certificate.

5. The method of claim 1 further comprising providing an interface to allow the initial claimant to swear that a persona identified in the selected profile is owned by the initial claimant when allocating permission of controlling editability of the wiki portion of the selected profile.

6. The method of claim 1 further comprising automatically removing defamatory wiki edits by periodically comparing profiles against an unauthorized content meta-data stored in a database and flagging those profiles having content which match the unauthorized content meta-data as candidates of removal.

7. The method of claim 1 further comprising electing neighborhood moderators to serve as arbitrators of the dispute resolution process based on a geo-fenced election between users of the geo-spatial social network embodying an environment where the wiki portions are modifiable until they are claimed.

8. The method of claim 1 further comprising enabling the wiki portion of the selected profile when an email confirmation bounces back from one of the initial claimant and the disputing claimant owning permission rights to the selected profile.

9. The method of claim 8 wherein the email confirmation is requested every six months.

10. The method of claim 1 in a form of a machine-readable medium embodying a set of instructions that, when executed by a machine, causes the machine to perform the method of claim 1.

11. A system, comprising:
a profile module to include a number of wiki profiles and a number of claimed profiles, wherein the wiki profiles are convertible to claimed profiles when users claim the wiki profiles;
a process module to enable the users to claim the wiki profiles, one per each email address, so that the wiki profiles convert to claimed profiles upon an oath, declaration, and supplemental identification pledge of a claimant; and
a resolve module to arbitrate disputes between the claimant and at least one disputing claimant through an electronic key verification technique.

12. The system of claim 11 wherein the electronic key is included in a mailer sent to an address location associated with a claimed wiki profile, and wherein the address information is tagged to each claimed wiki profile in the system.

13. The system of claim 12 further comprising a blocking module to temporarily disable access to disputed profiles in the system.

14. The system of claim 11 wherein the wiki profiles are modifiable by any user in the system prior to being claimed, and modifiable by others only at a discretion of the claimant when claimed.

15. The system of claim 14 further comprising a notification module to alert neighbors of a disputed profile, and to provide an interface to neighbors to help clarify ownership between disputing claimants through a voting mechanism between neighbors, wherein the neighbors are users having an address data a threshold distance away from the disputed profile.

16. The system of claim 15 further comprising a verification module to confirm that information posted to any wiki profile and to any claimed profile does not violate a privacy policy in which defamatory content is prohibited, and providing, in the interface to neighbors, a reporting mechanism such that neighbors submit violations of the privacy policy to an administrator of the system.

17. A method comprising:
associating address information with profiles of a geo-spatial social network;
enabling users a geo-fenced distance away from a particular profile to add content to the particular profile;
converting the particular profile to a proprietary profile that only is editable by a claimant when the claimant submits a claiming request of the profile;
temporarily blocking the proprietary profile when a disputing party challenges the claimant's dominion over the proprietary profile; and
releasing the proprietary profile to one of the claimant and the disputing party based on results of an electronic dispute resolution process in which a personally identifiable data is requested within a threshold window of time.

18. The method of claim 17 wherein the personally identifiable data has been pre-committed by the claimant and is requested of both the claimant and the disputing party at a time of dispute so as to provide forty-eight hours to upload the personally identifiable data to the geo-spatial social network.

19. The method of claim 18 further comprising performing an optical character and graphical representation analysis on the personally identifiable data so as to verify authenticity of the personally identifiable data against a third party identity verification database.

20. The method of claim 19 further comprising mailing a double-postcard that is folded and sealed to an address associated with the proprietary profile which assigns an ownership of the proprietary profile to a user who applies a code provided in the double-postcard to the proprietary profile, wherein the double-postcard qualifies as a first-class mail postcard having an embedded reply information in the double-postcard.
